(19) United States
(12) Patent Application Publication
(10) Pub. No.: US 2025/0244785 A1
(43) Pub. Date: Jul. 31, 2025

(54) CHARACTERISTIC COMPENSATION CIRCUIT

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Masaya KONDO, Nisshin-shi (JP); Yoshikazu FURUTA, Nisshin-shi (JP); Tomohiro NEZUKA, Nisshin-shi (JP); Kunihiko NAKAMURA, Nisshin-shi (JP)

(21) Appl. No.: 18/914,740

(22) Filed: Oct. 14, 2024

(30) Foreign Application Priority Data
Jan. 26, 2024 (JP) 2024-010238

(51) Int. Cl. G05F 3/18; G05F 1/567

(52) U.S. Cl. CPC G05F 3/185; G05F 1/567

(57) ABSTRACT

A characteristic compensation circuit includes a bias circuit, a first embedded Zener diode, a second embedded Zener diode, and a resistive divider. The first embedded Zener diode is biased by the bias circuit in a direction from a cathode, which is connected to a first node, to an anode, which is connected to a ground node. The second embedded Zener diode is biased by the bias circuit in a direction from an anode, which is connected to a second node, to a cathode, which is connected to the ground node. The resistive divider has a resistor connected between the first node and the second node. The resistive divider outputs a voltage based on the resistor. The resistive divider compensates for a temperature characteristic of the output voltage by weighting and summing a voltage applied to the first embedded Zener diode and a voltage applied to the second embedded Zener diode.

### CROSS REFERENCE TO RELATED APPLICATION

This application is based on Japanese Patent Application No. 2024-010238 filed on Jan. 26, 2024, the disclosure of which is incorporated herein by reference.

### TECHNICAL FIELD

The present disclosure relates to a characteristic compensation circuit.

### BACKGROUND

A reference power supply circuit may compensate for output variation affected by temperature characteristics. In the reference power supply circuit, the positive temperature characteristic of a Zener diode may be compensated for by using the negative temperature characteristic of a diode or a diode-connected bipolar junction transistor (BJT).

### SUMMARY

The present disclosure describes a characteristic compensation circuit including a bias circuit, a first embedded Zener diode, a second embedded Zener diode, and a resistive divider circuit.

### BRIEF DESCRIPTION OF DRAWINGS

FIG. 1 illustrates the configuration of a characteristic compensation circuit according to a first embodiment.

FIG. 2 illustrates an example of the characteristic compensation circuit according to the first embodiment.

FIG. 3 illustrates an example of the layout configuration of an embedded Zener diode according to the first embodiment.

FIG. 4 illustrates an example of a characteristic compensation circuit according to a second embodiment.

### DETAILED DESCRIPTION

Diodes and diode-connected BJTs may be susceptible to stress, and the output voltage may fluctuate due to stress variations caused by factors such as package distortion.

According to an aspect of the present disclosure, a characteristic compensation circuit includes: a bias circuit; a first embedded Zener diode that is biased by the bias circuit in a direction from a cathode connected to a first node to an anode connected to a ground node; a second embedded Zener diode that is biased by the bias circuit in a direction from an anode, which is connected to a second node, to a cathode, which is connected to the ground node; and a resistive divider in which a resistor is connected between the first node and the second node. In addition, a voltage based on the resistor in the resistive divider is output.

The voltage applied to the first embedded Zener diode and the voltage applied to the second embedded Zener diode are weighted and summed by the resistive divider to compensate for the temperature characteristics of the voltages of the first and second embedded Zener diodes.

According to the above aspect, since a forward-biased second embedded Zener diode is used instead of a normally forward-biased diode or a diode-connected BJT, the output voltage becomes less susceptible to variations due to stress fluctuations. As a result, fluctuations in the output voltage due to stress variations can be suppressed.

Several embodiments of characteristic compensation circuits are hereinafter described with reference to the drawings. In the following embodiments, substantially same structural configurations are designated with the same reference symbols to simplify the description.

### First Embodiment

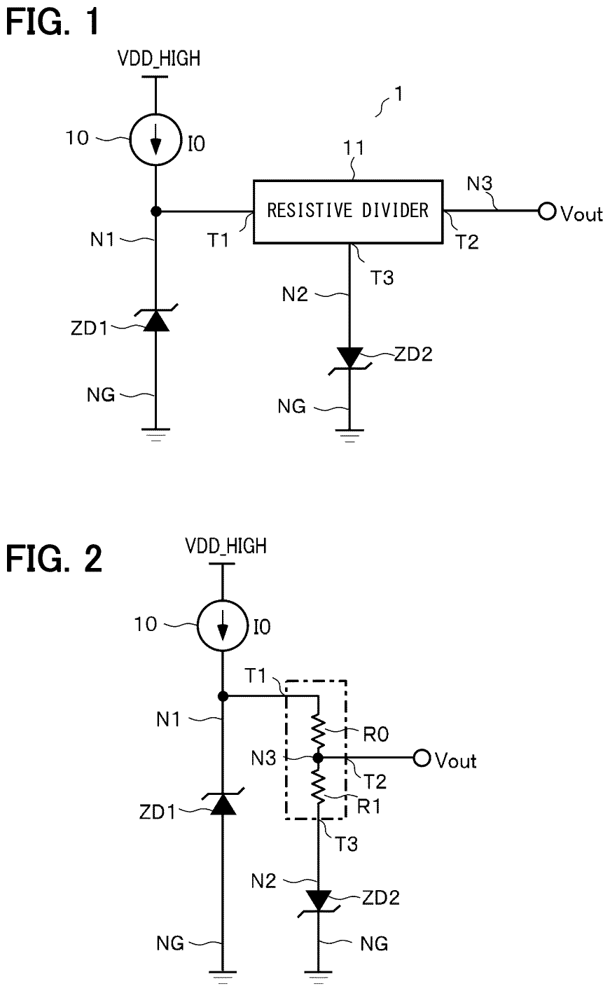

The following describes a first embodiment with reference to FIGS. 1 to 3. A temperature compensation circuit 1, which functions as a characteristic compensation circuit, includes a current source 10 acting as a bias circuit, a first embedded Zener diode ZD1, a second embedded Zener diode ZD2, and a resistive divider 11. The resistive divider 11 may also referred to as a voltage divider being a divider circuit. In the following, the first embedded Zener diode ZD1 may also be referred to as a Zener diode ZD1; and the second embedded Zener diode ZD2 may also be referred to as a Zener diode ZD2.

The current source 10 generates a constant current I0 based on a power supply voltage VDD_HIGH and outputs the generated constant current IO to a first node N1. The cathode of the Zener diode ZD1, a first terminal T1 of the resistive divider 11, and the current source 10 are connected to a first node N1. The anode of the Zener diode ZD2 and a third terminal T3 of the resistive divider 11 are connected to a second node N2. The second terminal T2 of the resistive divider 11 is connected to a third node N3. The third node N3 is a terminal for the output voltage Vout.

The cathode of the Zener diode ZD1 is connected to the first node N1, and the anode of the Zener diode ZD1 is connected to a ground node NG. The Zener diode ZD1 is reverse-biased by the current source 10 from the cathode of the Zener diode ZD1 to the anode of the Zener diode ZD1. Only one Zener diode ZD1 is connected.

The anode of the Zener diode ZD2 is connected to the second node N2, and the cathode of the Zener diode ZD2 is connected to the ground node NG. The Zener diode ZD2 is forward-biased by the current source 10 from the anode of the Zener diode ZD2 to the cathode of the Zener diode ZD2. The Zener diode ZD2 is shown as a single connection at the relevant point, but it may also be configured by connecting multiple diodes in series.

The resistive divider 11 is connected between the first node N1 and the second node N2. The resistive divider 11 has multiple resistors R0, R1, which divide the voltage between the first node N1 and the second node N2. Each of the multiple resistors R0, R1 may also be referred to as a voltage-dividing resistor. As illustrated in FIG. 2, the resistors R0, R1 are connected between the first terminal T1 and the third terminal T3 of the resistive divider 11.

As shown in FIG. 1, the temperature compensation circuit 1 outputs a voltage based on the resistors R0 and R1 of the resistive divider 11. As illustrated in FIG. 2, a divided voltage at the third node N3, which is acquired from a voltage divided by the resistors R0 and R1 of the resistive divider 11, is output.

The temperature compensation circuit 1 compensates for the temperature characteristics of the voltages of Zener diodes ZD1 and ZD2 by weighted addition of the voltages across Zener diodes ZD1 and ZD2 using the resistive divider 11.

### (Layout Example of Zener Diodes ZD1 and ZD2)

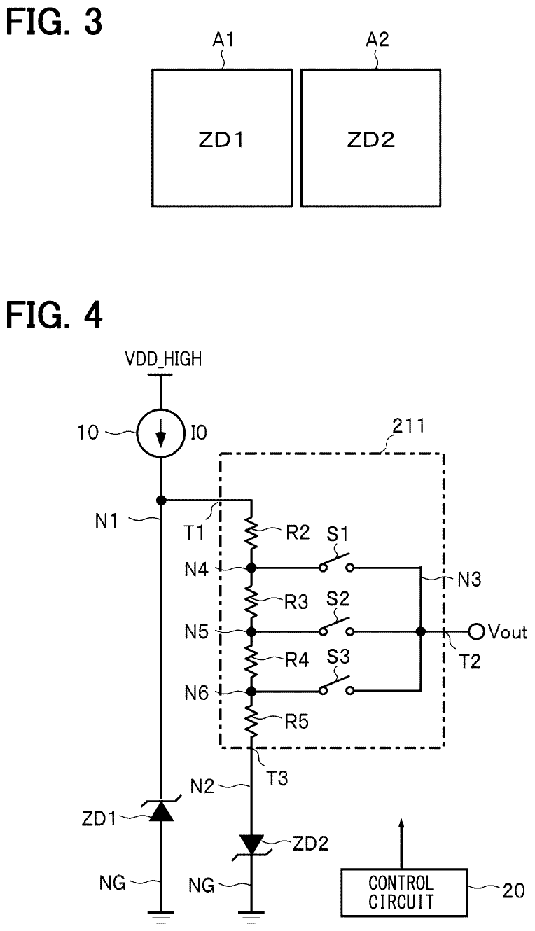

As shown in FIG. 3, the Zener diodes ZD1 and ZD2 both have the same planar layout structure (for example, a rectangular shape). Further, the formation areas A1 and A2 of these Zener diodes ZD1 and ZD2 are disposed adjacent to each other.

The following describes the principle of temperature compensation according to the first embodiment. The voltage at the first node N1, to which the reverse-biased Zener diode ZD1 is connected, is defined as the Zener voltage V_{Z}. The voltage between the anode and cathode of the forward-biased Zener diode ZD2 is defined as the forward voltage V_{D}. If the weighting coefficients are α and β, the mathematical expression for the output voltage Vout, which is the weighted sum by the resistive divider 11, can be described by the following equation (1) as follows.

$$Vout = α {V}_{z ( r e v e r s e )} + β {V}_{z ( f o r w a r d )} \qquad ( 1 )$$

Therefore, in the specific configuration shown in FIG. 2, the output voltage Vout can be described by the following equation (2), where the Zener voltage V_{Z} and the forward voltage V_{D} are weighted and summed according to the resistive ratio.

$$Vout = \frac{{R}_{1}}{{R}_{0} + {R}_{1}} {V}_{z} + \frac{{R}_{0}}{{R}_{0} + {R}_{1}} {V}_{D} \qquad ( 2 )$$

By partially differentiating equation (2) with respect to the temperature T, the temperature characteristic of the output voltage Vout can be obtained as follows in the following equation (3).

$$\frac{\partial V o u t}{\partial T} = \frac{{R}_{1}}{{R}_{0} + {R}_{1}} \frac{\partial {V}_{z}}{\partial T} + \frac{{R}_{0}}{{R}_{0} + {R}_{1}} \frac{\partial {V}_{D}}{\partial T} \qquad ( 3 )$$

In general, the temperature characteristic ∂V_{D}/∂T of the forward-biased Zener diode ZD2 is negative. Therefore, it is possible to form the reverse-biased Zener diode ZD1 such that its temperature characteristic ∂V_{D}/∂T is positive. By adjusting the resistors R0, R1 to an appropriate ratio, the temperature characteristic of the output voltage Vout can be optimized to achieve the appropriate state.

### Summary of First Embodiment

In the placement location of the Zener diode ZD2 as described in this embodiment, a general forward-biased diode or a diode-connected bipolar junction transistor (BJT) may be often used. However, in these methods, the fluctuation of the output voltage Vout may increase with respect to the fluctuation of stress. Especially in automotive applications, it is necessary to withstand various vibrations, and it is undesirable for the output voltage Vout to fluctuate significantly due to these vibrations.

Therefore, in this embodiment, the embedded Zener diode ZD2 is used to generate the forward bias voltage VD. The embedded Zener diodes ZD1 and ZD2 have a junction deeper than the surface of the semiconductor wafer in manufacturing. For this reason, they are less susceptible to stress than ordinary diodes or diode-connected BJTs. As a result, it becomes less susceptible to stress compared to regular diodes or diode-connected BJTs, and the stress dependence of the output voltage Vout can be minimized as much as possible. As a result, a configuration that is less affected by stress compared to comparative setups can be achieved, allowing for the creation of a reference power supply circuit with minimal stress dependence.

In this embodiment, the voltage Vz across the Zener diode ZD1 and the voltage V_{D} across the Zener diode ZD2 are weighted and added by the resistive divider 11 to compensate for the temperature characteristics of the output voltage Vout. Specifically, the voltage difference between the cathode and anode of the reverse-biased Zener diode ZD1 has a positive temperature characteristic, while the voltage difference between the cathode and anode of the forward-biased Zener diode ZD2 has a negative temperature characteristic. And then, the voltages VZ and VD are weighted and summed by the resistive divider 11 in such a way that their respective temperature characteristics cancel each other out, and the resulting output voltage is provided as Vout. As a result, a reference power supply circuit can be constructed that compensates for temperature characteristics, reduces stress dependence, and also minimizes temperature dependence.

The resistive divider 11 includes a series-connected circuit of the resistors R0, R1. The divided voltage acquired from these multiple resistors R0 and R1 is provided as the output voltage Vout, thus achieving this with a simple configuration.

### Second Embodiment

The following describes a second embodiment with reference to FIG. 4. FIG. 4 illustrates an example of the configuration of a resistive divider 211 instead of FIG. 2. The resistive divider 211 includes multiple resistors R2 to R5 and multiple semiconductor switches S1 to S3. Each of the resistors R2 to R5 may also be referred to as a voltage-dividing resistor. The resistors R2 to R5 are connected in series that create multiple common connection nodes N4 to N6 between adjacent two of the resistors R2 to R5. The semiconductor switches S1 to S3 are connected in parallel to the resistors R2 to R5, and include: input terminals that are connected to the common connections nodes N4 to N6, respectively; and output terminals that are commonly connected. A control circuit 20 includes a control logic circuit that controls the semiconductor switches S1 to S3 to be turned on and off. The resistive divider 211 outputs the divided voltage acquired based on the multiple resistors R2 to R5 as the output voltage Vout through the input and output terminals of the semiconductor switches S1 to S3.

In this embodiment, at least one of the semiconductor switches S1 to S3 is a metal-oxide semiconductor (MOS) transistor having one or more control terminals (gates). Each of the semiconductor switches S1 to S3 may be constructed, for example, by a single N-channel MOS transistor or a single P-channel MOS transistor. In addition, a metal-oxide-semiconductor field-effect transistor (MOSFET) is an example of the MOS transistor.

Additionally, the semiconductor switches S1 to S3 may be constructed by connecting the input and output terminals (drain/source) of N-channel MOS transistors and P-channel MOS transistors in parallel, respectively. The semiconductor switches S1 to S3 can switch between open and short states between the input terminal (drain) and the output terminal (source) in response to the voltage applied to the control terminal.

The terminals on one side of the semiconductor switches S1 to S3, which are made of MOS transistors, are all common, and the control circuit 20 can obtain an output voltage Vout with any desired resistance ratio by turning on only one of the semiconductor switches (for example, S1). Even in such a configuration, the same effect as that of the above-described embodiment can be obtained. The embodiment where the semiconductor switches S1 to S3 are connected to the common connection nodes N4 to N6 of the resistors R2 to R5 has been described, but this is not limited to this configuration. Another semiconductor switch may be connected between the first node N1 and the third node N3.

### OTHER EMBODIMENTS

The present disclosure is not limited to the above-described embodiments, i.e., may be modified or expanded in the following manner. The bias circuit is not limited to the current source 10. The second embedded Zener diode ZD2 may be connected in series with multiple diodes.

Although the present disclosure is described based on the above embodiments, the present disclosure is not limited to the disclosure of the embodiment and the structure. The present disclosure also includes various modifications and changes within the range of equivalency. In addition, various combinations and modes, and other combinations and modes including only one element, more elements, or less elements are also within the scope and idea of the present disclosure.

What is claimed is:

1. A characteristic compensation circuit comprising:
a bias circuit;
a first embedded Zener diode having a cathode connected to a first node, and an anode connected to a ground node, the first embedded Zener diode configured to be biased by the bias circuit in a direction from the cathode to the anode;
a second embedded Zener diode having a cathode connected to the ground node, and an anode connected to a second node, the second embedded Zener diode configured to be biased by the bias circuit in a direction from the anode to the cathode; and
a resistive divider having a resistor connected between the first node and the second node, the resistive divider configured to output an output voltage based on the resistor, wherein
the resistive divider is configured to compensate for a temperature characteristic of the output voltage by weighting and summing a first voltage and a second voltage, the first voltage being a voltage applied to the first embedded Zener diode, the second voltage being a voltage applied to the second embedded Zener diode.

2. The characteristic compensation circuit according to claim 1, wherein
the resistive divider includes resistors connected in series, and
the resistive divider is configured to output, as the output voltage, a divided voltage based on the resistors.

3. The characteristic compensation circuit according to claim 1, wherein
the resistive divider includes
resistors connected in series,
common connection nodes between adjacent two of the resistors, and
semiconductor switches connected in parallel to the resistors, the semiconductor switches including
input terminals connected to the common connection nodes, respectively, and
output terminals commonly connected, and
the resistive divider is configured to output a divided voltage, which is acquired based on the resistors, through an input terminal and an output terminal of one of the semiconductor switches.

4. The characteristic compensation circuit according to claim 1, wherein
a layout of the first embedded Zener diode is same as a layout of the second embedded Zener diode.

5. The characteristic compensation circuit according to claim 1, wherein
the first embedded Zener diode is located to be adjacent to the second embedded Zener diode.

6. The characteristic compensation circuit according to claim 3, wherein
each of the semiconductor switches includes at least one metal-oxide-semiconductor transistor having at least one control terminal, and
each of the semiconductor switches is configured to switch between an open state and a short state between an input terminal and an output terminal based on a voltage applied to the at least one control terminal.
